(19) United States
(12) Patent Application Publication
(10) Pub. No.: US 2002/0088155 A1
(43) Pub. Date: Jul. 11, 2002

(54) Sign unit

(76) Inventor: Kurt Persson, Solvang, CA (US)

Correspondence Address: Benton S. Duffett, Jr., BURNS, DOANE, SWECKER & MATHIS, L.L.P., P.O. Box 1404, Alexandria, VA, 22313-1404, US

(21) Appl. No.: 10/022,242

(22) Filed: Dec. 20, 2001

Related U.S. Application Data
(60) Provisional application No. 60/260,224, filed on Jan. 9, 2001.

(30) Foreign Application Priority Data
Dec. 22, 2000 (SE) 0004785-2

(51) Int. Cl. G09F 13/20

(52) U.S. Cl. 40/542

(57) ABSTRACT

A sign unit which is adapted to be supported with at least a portion exposed to incident light, comprising a sheet-like device (1) with a front (3) exhibiting the information of the sign unit and with a back (4) opposite to the front. At least one light-emitting member (2) is arranged on the sheet-like device. The light-emitting member (2) has a front end (5) which is positioned at or in front of the front (3) of the sheet-like device (1) and a rear opposite end (6). Said member (2) is made of a fluorescent plastic material and has a thickness which is considerably smaller than its length between said front (5) and rear (6) ends and the member (2) is adapted to absorb, between said ends (5, 6), incident light (13) and conduct this to the front end (5) for emission (26) at the front (3) of the sign unit.

The present invention relates to a sign unit which is adapted to be supported with at least a portion exposed to incident light, comprising a sheet-like device with a front exhibiting the information of the sign unit and with a back opposite to the front, and at least one light-emitting member which is arranged on the sheet-like device.

More specifically, the invention relates to a sign unit with lighting or with selected portions of the sign accentuated by radiating/emitting light. Road signs and the like with lighting or with warning lights are previously known. However, they must be supplied with power and be maintained (lamps must be exchanged) to function in the intended fashion. This is not a very great problem in or outside communities, but in uninhabited areas the supply of power is very unreliable. From the viewpoint of maintenance, it is of course also desirable to have traffic signs which require a minimum of service.

The object of the invention is to provide a sign unit with radiation of light, which need not be provided with power or lamps.

A further object of the invention is to provide a sign unit with radiation of light which has good contrast ratio to the rest of the sign.

Another object is to provide a sign with light-emitting members which are cheap to produce and which are rugged and easy to mount.

According to the invention, these objects are achieved by means of a sign unit which is of the type described by way of introduction and which is characterized in that said light-emitting member has a front end which is positioned at or in front of the front of the sheet-like device and a rear opposite end, that said member is made of a fluorescent plastic material and has a thickness which is significantly smaller than its length between said front and rear ends, said member being adapted to absorb, between said ends, incident light and conduct this to the front end for emission at the front of the sign unit.

Further developments of the invention are evident from the features defined in the subclaims.

Preferred embodiments of the invention will now be described by way of example and with reference to the accompanying drawings, in which

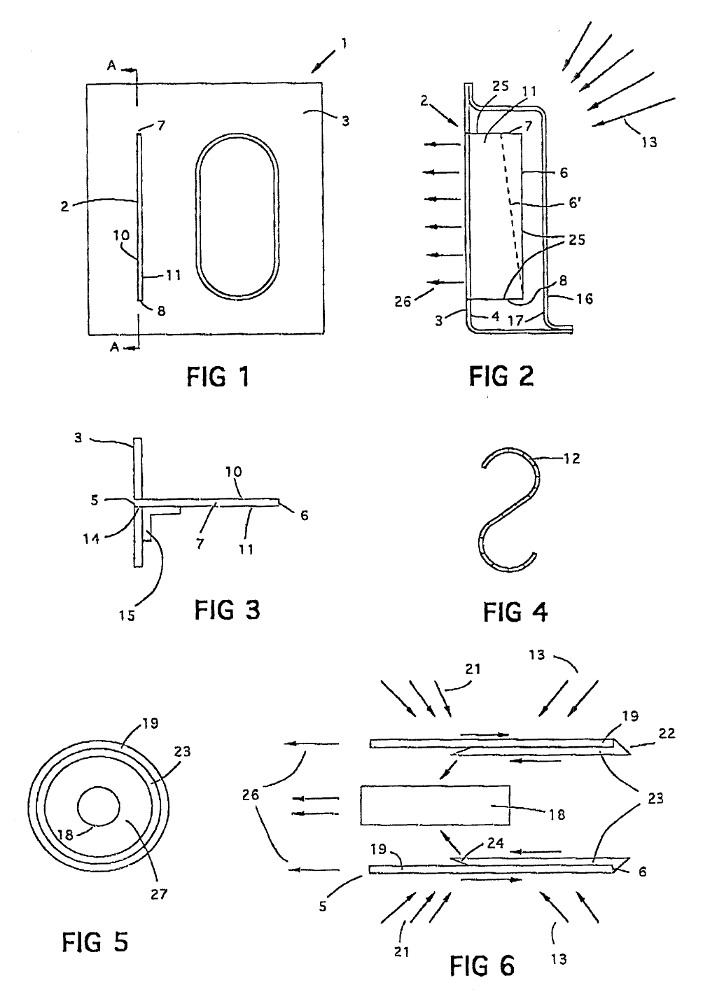

FIG. 1 is a schematic view of a preferred embodiment of a sign unit according to the invention;

FIG. 2 is a section along line A-A in FIG. 1 illustrating the function of the sign unit;

FIG. 3 shows an example of how a light-emitting member can be attached to the sheet-like device of the sign unit;

FIG. 4 illustrates an alternative embodiment of a light-emitting member according to the invention;

FIG. 5 illustrates a composed light-emitting member according to the invention, seen from the front of the sign unit;

FIG. 6 illustrates the beam path in the light-emitting member according to FIG. 6;

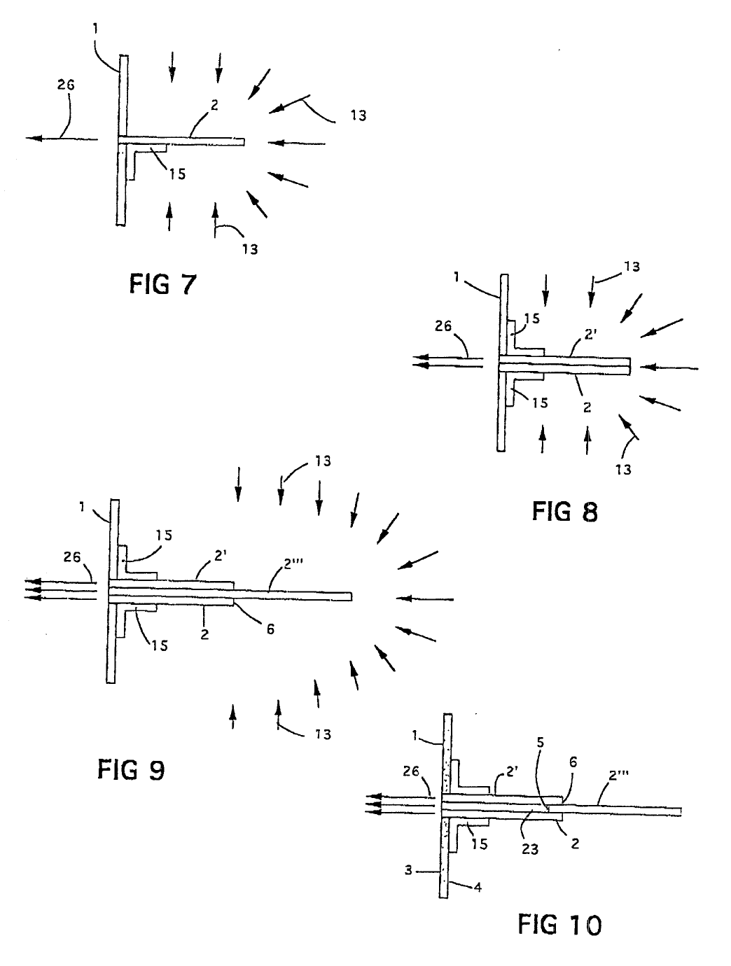

FIG. 7 shows the embodiment according to FIG. 1 in a partial top plan view, i.e. perpendicular to the view in FIG. 2;

FIG. 8 is a view similar to the one in FIG. 7 of a first variant of the embodiment according to FIG. 7.

FIG. 9 is a view similar to the one in FIG. 7 of a second variant of the embodiment according to FIG. 7; and

FIG. 10 is a view similar to the one in FIG. 7 of a third variant of the embodiment according to FIG. 7.

The sign unit is mainly intended for outdoor use as a road sign or some other sign-supported piece of information, attached to a post or the like or suspended from an associated suspension device. It is also suited for indoor use, for instance in department stores, shopping malls, pedestrian zones and the like, i.e. in illuminated spaces.

With reference first to FIGS. 1-3, a sign unit according to the invention mainly comprises a sheet-like device 1 and one or more light-emitting members 2.

The sheet-like device 1 has a front 3 with the information of the sign, i.e. its symbols, picture and, or marks, exposed to a viewer. This is schematically illustrated in FIG. 1 where the FIG. 10 is the most essential information. The front 3 is conveniently coated with a dark background color to obtain optimal readability, i.e. contrasting effect, as regards the marks formed by the light-emitting members 2 on the front 3 of the sheet-like device, as will be explained in more detail below. Opposite to the front 3, the device 1 also has a back 4 which advantageously is bright finished or is coated with a reflecting layer. Moreover, the sheet-like device is preferably plane, but if desired, it may be curved or bent, and is made of e.g. plastic material or metal, such as aluminum.

The light-emitting member 2 is arranged on, and preferably fixed to, the sheet-like device 1 and has a front end 5 which is positioned at or in front of the front 3 of said device, and a rear opposite end 6. In FIG. 3, the light-emitting member 2 is illustrated in the form of a sheet having a thickness which is considerably smaller (in the order of 5 mm) than its length between its front 5 and rear 6 ends. The front end or edge side 5 is polished and uncoated, while the rear end or edge side 6 is coated with a reflecting layer 25, a mirror element or a prismatic body, which also applies to the edge sides 7 and 8 between the ends 5 and 6. The other two larger lateral surfaces 10 and 11 of the light-emitting member constitute the light-absorbing surfaces of the member.

The body, defined by the edge sides 5, 6 and the lateral surfaces 10-11, of said member 2 is made of a light-absorbing/light-guiding material, such as acrylic plastic to which a fluorescent substance has been supplied, luminant nylon (nylon with luminescence), glass of the type optical fiber and the like, of an optional color, although red is preferred. In the preferred embodiment, the lateral surfaces 10 and 11 are coated with a surface layer having a refractive index such that surrounding light absorbed through the lateral surfaces is essentially totally reflected within the device (mirrored) and emitted through the uncoated front end 5. The other edge sides 6-8 do not emit light but retro-reflect this into the body.

In FIG. 1, the member 2 is illustrated in the form of a plane sheet (the FIG. 1) and a sheet bent to the FIG. 0 (for the sake of clarity, the adjoining ends of the sheet have not been illustrated) or an extruded tubular section. It is also possible to construct said member 2 of a plurality of rod-shaped or bar-shaped elements 12 which are arranged side by side, as illustrated in FIG. 4. Since the incident light, especially daylight indicated by the arrows 13 in FIGS. 2 and 7-10, in most cases falls on said member 2 obliquely from above, it may be convenient to form the member 2 in such manner that the length between its ends 5 and 6 increases from the upper portion of the member (in the mounted state of the sign unit) towards the lower portion of the member, as indicated by the dashed line 6′ in FIG. 2.

When the inventive idea is applied, for instance, to a road sign, the light-emitting member 2 can be formed as a frame round the sheet-like device 1 (not shown), but preferably the member 2 forms the mark or symbol that constitutes the most essential information of the sign unit. This information will be accentuated by said light-emission 26 from the front end 5 of the light-emitting member 2 in contrast to the (darker) background color of the sign front 3, which background color is the rest of the sign information (picture). One of the advantages of the sign unit is that it has a passive brightness controlling function. The more surrounding light, the brighter light picture and vice versa in case of dimmer surrounding light. The sheet-like device 1 is therefore formed with through slots 14 of preferably the same shape as the cross-sectional shape of the light-emitting members 2, in which slots 14 said members are inserted. (The members 2 can also be suspended in front of or behind the device 1, but this is not a preferred embodiment of the invention.) Preferably, said members 2 are inserted essentially perpendicular to the plane of the device 1 and their front end 5 is positioned at the front 3 of the sheet-like device, on a level with or slightly projecting from the same. It goes without saying that it is possible to position the front end 5 at a considerable distance in front of the front 3, in which case a larger part of the light-absorbing lateral surfaces 10, 11 of the member 2 will be located in front of said front 3, instead of behind the same, as shown in FIG. 2.

The light-emitting member 2 can be firmly fixed in said slots 14 by using a press fit, a binder, welding and the like and/or by means of a bracket arrangement 15, as shown in FIG. 3.

A cover or casing 16 is arranged to protect the portion, projecting from the device 1, of the light-absorbing body of the light-emitting member 2, the casing being fixed to the back 4 of the sheet-like device 1 (or, where applicable, to the front 3), see FIG. 2. The casing 16 is made of a transparent material, preferably translucent plastic, and is internally provided with a diffusion layer 17 for spreading and leveling the incident light 13 over the entire light-absorbing surface 10, 11 of the light-emitting member 2.

If a wider light-emitting surface is desirable, corresponding to said front end 5, the front end portion can be made thicker than the rest of the light-emitting member 2, or the member 2 can be formed of two or more adjoining layers (not shown) in which case rays that are directed towards the rear end 6 of one layer (the outermost layer) are reflected into the rear end of the other layer (the innermost layer) in order to radiate from the front end of the innermost layer similarly to that described in the following with reference to FIG. 6 (in this case the element 23 corresponds to the inner layer and is terminated with a straight, polished end in the same plane as said front end 5).

In the cases where the light-emitting member 2 comprises a portion 18 which is surrounded by another portion 19, as schematically illustrated in FIG. 5, it may be difficult to obtain enough incident light for the surrounded portion 18 since this is shielded by the surrounding portion 19. This results in the inner portion 18 shining more dimly than the outer portion 16, which is not desirable.

A way of solving this problem in addition to that described above, i.e. compensating for the lower intensity of the incident light 13 by varying (in the vertical direction) the length of the light-emitting member 2 (cf. 6′), is illustrated in FIG. 6. FIG. 6 shows how light falls on the light-emitting member 2 from (two) different directions. The beam of light 13 which falls at an oblique angle onto the peripheral surface of the member 2 towards the end surface 5 is reflected towards and radiates from this end surface (see arrows 26). The beam of light 21 falling in the opposite direction onto the peripheral surface is reflected towards and radiates from the opposite end surface 6 of the member 2. A reflecting device 22 is arranged at the end surface 6 for retro-reflecting light originating from the “incorrectly” incident light, such as the light beam 21 above. The light radiating from the end surface 6 is reflected by the device 22 into an elongate element 23 made of a substance of light-permeable material with a small degree of attenuation of light which is arranged at and along the outer portion 19 of the light-emitting member 2, inside said outer portion. The element 23 is preferably a transparent cylindrical tube of acrylic plastic. It can also be a transparent, fiber-optics conductor of glass or some other convenient material. The reflecting device 22 is preferably a device with mirror surfaces and is a separate unit or is formed integrally with the element 23. It can also be a prism-like component. At the other, opposite end of the elongate element 23, a second reflecting device 24 is arranged, which directs the reflecting light into the inner portion 18 of the light-emitting member 2 for emission at the front 3 of the sign unit. The light guiding element 23 is in FIG. 6 shown to be arranged at a distance from the inner portion 18 with an annular gap 27 between them, but, of course, it is also possible to connect the element 23 to the portion 18, for instance by means of an annular projection at the end of the element 23, said end being provided with the reflecting device 24 fixed to the element 18. This has the advantage that the inner portion 18 is thus positioned in an easy way.

As will be easily understood by a person skilled in the art it is also possible to use the technique involving the elongate light-guiding element 23 to conduct light to the lower portion of the light-emitting member 2 and, thus, obtain emission of light 26 from the member 2 which is essentially constant over its entire front end surface 5.

FIG. 8 schematically illustrates how a wider light-emitting surface can be obtained by arranging two light-emitting members 2 and 2′ adjacent to one another.

FIG. 9 illustrates similarly how a still wider or larger light-emitting surface is obtained by arranging three light-emitting members 2, 2′ and 2″ adjacent to each other. Since the innermost or center member 2″ is shielded by the surrounding or enclosing members 2 and 2′, preferably the member 2″ has a greater length than the members 2 and 2′, in which case that portion of the member 2″ which projects from the rear ends 6 of the surrounding members 2 and 2′ can unimpededly absorb incident light 13.

Since the intensity of the absorbed light is attenuated in dependence on the distance it travels in the light-guiding (light-emitting) member 2, the radiation of light 26 from the center member 2″ will be weaker than from the surrounding members 2 and 2′. In many cases, this is not particularly important, but in some applications (for instance, when the member 2″ has a color which differs from the color of the members 2 and 2″) it may be desirable to obtain essentially the same intensity of the light emission from all members 2, 2′ and 2″. This has been solved with the embodiment according to FIG. 10. According to this embodiment, essentially the entire portion of the center member 2 which is enclosed or surrounded by the outside members 2 and 2″ has been replaced by a light-guiding element 23 with a small degree of attenuation of light, preferably one like that presented in connection with FIG. 6. The front end 5 of the center member 2″ is arranged at a distance behind the back of the sheet-like device 1. Said element 23 is positioned between the front end 5 and the device 1 and is terminated preferably at the front 3 of the device i.

In connection with the various Figures, different features of the sign unit according to the invention have been presented. It is, of course, feasible to combine/replace the features illustrated in the Figures with each other, if desirable.

The invention is not restricted to that described above and shown in the drawings and can be modified within the scope of the appended claims.

What I claim and desire to secure by Letters Patent is:

1. A sign unit which is adapted to be supported with at least a portion exposed to incident light, comprising a sheet-like device (1) with a front (3) exhibiting the information of the sign unit and with a back (4) opposite to the front, and at least one light-emitting member (2) which is arranged on the sheet-like device, characterized in that said light-emitting member (2) has a front end (5) which is positioned at or in front of the front (3) of the sheet-like device (1) and a rear opposite end (6), that said member (2) is made of a fluorescent plastic material and has a thickness which is considerably smaller than its length between said front (5) and rear (6) ends, said member (2) being adapted to absorb, between said ends (5, 6), incident light (13) and conduct this to the front end (5) for emission (26) at the front (3) of the sign unit.

2. A sign unit as claimed in claim 1, characterized in that the sheet-like device (1) has at least one through slot (14), that at least one light-emitting member (2) is arranged in said slot (14), and that said member (2) is included in the information of the sign unit.

3. A sign unit as claimed in claims 1 and 2, characterized in that said light-emitting member (2) is inserted into the associated slot in the sheet-like device (1) in such manner that the front end (5) of said member (2) is positioned at the front (3) of the sheet-like device (1) and its rear opposite end (6) is positioned at a considerable distance behind the back (4) of the device (1).

4. A sign unit as claimed in any one of the preceding claims, characterized in that the light-emitting member (2) is a sheet-like element which is straight and/or curved in cross-section.

5. A sign unit as claimed in any one of claims 1-3, characterized in that the light-emitting member (2) is tubular (19).

6. A sign unit as claimed in any one of claims 1-3, characterized in that the light-emitting member (2) comprises a plurality of rod-shaped or bar-shaped elements (12) which are arranged side by side.

7. A sign unit as claimed in any one of the preceding claims, characterized in that the light-emitting member (2) comprises a number of elements in the shape of a sheet (2, 2′, 2″), tube (19) and/or rod (12).

8. A sign unit as claimed in any one of the preceding claims, characterized in that the length between the ends (5, 6) of the light-emitting member (2) increases from the upper portion of said member in the mounted state of the sign unit (1) towards the lower portion (6′) of the member.

9. A sign unit as claimed in any one of the preceding claims, characterized in that the edge sides (6-8) of the light-emitting member (2) which are not intended to emit light are provided with emissionpreventing means, such as a reflective coating (25), a prismatic body (22), a mirror element or the like.

10. A sign unit as claimed in any one of the preceding claims, characterized in that the portion (10, 11), projecting from the sheet-like device (1), of the light-emitting member (2) is enclosed in a casing (16) which is fixed to said device (1) and which is made of a transparent material.

11. A sign unit as claimed in claim 10, characterized in that the casing (16) is coated with a diffusion layer (17) for spreading and leveling the incident light (13) over the entire light-absorbing surface (10, 11) of the light-emitting member (2).

12. A sign unit as claimed in any one of the preceding claims, characterized in that the light-emitting member (2) comprises an inner portion (18) and, surrounding the same, an outer portion (19), and that a light-guiding element (23) with a small degree of attenuation of light is arranged adjacent to and along the outer portion (19) and inside the same, that a first reflective device (22) is arranged at the rear end of the outer portion (19) in order to reflect light from said portion (19) into one end of the light-guiding element (23), and that a second reflective device (24) is arranged at the other opposite end of the light-guiding element (23) to reflect light from the light-guiding element (23) into the other portion (18).

13. A sign unit as claimed in any one of claims 1-11, characterized in that the light-emitting member (2) comprises an inner member (21″) and, surrounding the same, outer members (2, 2′), and that the inner member (2″) projects from the rear end (6) of the surrounding member/members (2, 2′).

14. A sign unit as claimed in claim 13, characterized in that the front end (5) of the inner member (2″) is arranged at a distance behind the back (4) of the sheet-like device (1), and that a light-guiding element (23) with a small degree of attenuation of light is arranged between said front end (5) and the sheet-like device (1).
